(19) United States
(12) Patent Application Publication
(10) Pub. No.: US 2011/0293975 A1
(43) Pub. Date: Dec. 1, 2011

(54) TEST METHOD FOR LITHIUM-ION SECONDARY BATTERY

(75) Inventors: Masahiro Iyori, Osaka (JP); Toyoki Fujihara, Naruto-shi (JP); Yasuhiro Yamauchi, Sumoto-shi (JP); Toshiyuki Nohma, Kobe-shi (JP)

(73) Assignee: SANYO ELECTRIC CO., LTD., Osaka (JP)

(21) Appl. No.: 13/117,739

(22) Filed: May 27, 2011

(30) Foreign Application Priority Data
May 28, 2010 (JP) 2010-123399

(51) Int. Cl. H01M 10/48

(52) U.S. Cl. 429/90

(57) ABSTRACT

The test method for a lithium-ion secondary battery comprises a measuring potential difference Δ between an outer can and a negative electrode external terminal after a charging process, and if the potential difference Δ is a predetermined prescribed value or greater, the battery is determined as a non-defective product. This method can more accurately detect a battery in which a short circuit occurs temporarily, for example, when the negative electrode external terminal and the outer can come into contact simultaneously with a manufacturing apparatus than the case when a potential difference between the positive electrode external terminal and the outer can is measured. Thus the method can reduce the possibility of corrosion of the outer can due to lithium metal deposited on the inner surface of the outer can.

### TECHNICAL FIELD

The present invention relates to a test method for a lithium-ion secondary battery. More specifically, the present invention relates to a test method for a lithium-ion secondary battery that allows easy detection of a lithium-ion secondary battery in which a short circuit occurs temporarily, for example, when the negative electrode external terminal and the outer can come into contact simultaneously with a manufacturing apparatus or the like during manufacturing of the battery, whereby a reliable lithium-ion secondary battery can be sorted out with a reduced possibility of corrosion of the outer can due to lithium metal deposited on the inner surface of the outer can.

### BACKGROUND ART

In recent years, with the rise of the environmental movement, the emission control of green house gases such as carbon dioxide gas has been strengthened. In response, the automobile industry has been actively developing electric vehicles (EV) and hybrid electric vehicles (HEV) in place of automobiles using fossil fuels such as gasoline, diesel oil, or natural gases. Nickel metal hydride secondary batteries and nonaqueous electrolyte secondary batteries are used as the batteries for EV and HEV. In recent years, nonaqueous electrolyte secondary batteries such as lithium-ion secondary batteries are widely used because they are lightweight and have high storage capacity.

In a lithium-ion secondary battery for use in the application of EV and HEV, a power-generation element is accommodated in a prismatic or cylindrical outer can made of aluminum or aluminum alloy. A large number of batteries are connected in series and parallel to form a battery unit capable of discharging high voltage and large current. Therefore, a failure of even one battery in a battery unit harms the entire battery unit. Thus, a lithium-ion secondary battery used in a battery unit has to be highly reliable.

In a lithium-ion secondary battery, a power-generation element formed by stacking and winding a positive electrode plate and a negative electrode plate is covered with an insulating layer on the outer periphery thereof and is thus electrically isolated from an aluminum or aluminum alloy outer can. The aluminum or aluminum alloy outer can essentially has no polarity. However, a short circuit may temporarily occur, for example, when the negative electrode external terminal and the outer can come into contact simultaneously with a manufacturing apparatus or the like during the manufacturing process. In such a case, electrons may flow from the negative electrode external terminal to the outer can, and in addition, lithium ions may dissolve from the negative electrode plate into the nonaqueous electrolyte and then move to the outer can to be deposited as lithium metal on the inner surface of the outer can.

The lithium metal thus deposited on the inner surface of the outer can is easily alloyed with aluminum or aluminum alloy, which is a material forming the outer can. When the lithium metal is alloyed with aluminum or aluminum alloy, the outer can becomes corroded and develops holes, in the worst case, because of a large coefficient of volume expansion and high reactivity with moisture. Thus, a battery with poor reliability may be produced. Therefore, in the final stage of the manufacturing process, it is necessary to be able to sort out batteries having a temporary short circuit between the negative electrode external terminal and the outer can.

On the other hand, JP-A-2005-251685 discloses a test method for a nonaqueous electrolyte secondary battery having a laminate outer body. This test method aims to prevent generation of lithium-aluminum alloy caused by electrical contact between the negative electrode and aluminum metal of the laminate outer body when a pin hole is present in an inner surface resin layer of the laminate outer body. For this purpose, using a voltmeter with an input impedance of 1 GΩ or higher, a battery is determined as a non-defective product if voltage between the positive electrode terminal and a metal layer at a heat seal portion of the laminate outer body is 0.2 V to 3.1 V.

JP-A-2002-324572 discloses an insulation test method for a nonaqueous electrolyte sealed battery using a metal-resin composite film as an outer body. In this test method, in order to test whether a short circuit occurs between the positive electrode terminal and the negative electrode terminal with a metal foil substrate of the metal-resin composite film interposed therebetween, the insulation state between the positive electrode terminal or the negative electrode terminal and the metal foil substrate is determined using a resistance meter.

JP-A-3-67473 discloses a test method for a sealed lead-acid battery. In this method, voltage is applied between the external terminal of a sealed acid-lead battery and the outer case laminated with a resin layer on the inner surface thereof, and conduction current or voltage drop at the time of voltage application is detected, whereby poor sealing or electrification of the outer case is detected.

In the test method for a nonaqueous electrolyte secondary battery disclosed in JP-A-2005-251685, when a pin hole is present, for example, in the resin on the inner surface side of the laminate outer body, a battery having a short circuit between the metal layer of the laminate outer body and the negative electrode may be sorted out by detecting voltage between the metal layer of the laminate outer body and the positive electrode. However, a nonaqueous electrolyte secondary battery with a pin hole in the resin on the inner surface side of the laminate outer body cannot be permitted as a normal battery. Moreover, JP-A-2005-251685 provides no suggestion as to sorting out a lithium-ion secondary battery having a metal outer can, rather than the laminate outer body, in which no short circuit occurs between the outer can and the negative electrode but a short circuit occurs temporarily simply because the negative electrode external terminal and the outer can come into contact simultaneously with a manufacturing apparatus or the like in the manufacturing process.

In a nonaqueous electrolyte secondary battery, the range of changes of positive electrode potential with respect to the changing state of charge (SOC) of the battery is greater than the range of changes of negative electrode potential. Thus, if the potential difference between the positive electrode external terminal and the outer can is used as a basis for determination, even a slight change of the battery voltage at the time of test measurement has an effect on potential measurement, and therefore, a correct measurement cannot be obtained.

In the insulation test method for a sealed battery as disclosed in JP-A-2002-324572 and the test method for a sealed lead-acid battery as disclosed in JP-A-3-67473, it is possible to sort out a battery having a short circuit between the metal layer of the laminate outer body and the negative electrode external terminal, for example, based on the presence of a pin hole in the resin on the inner surface side of the laminate outer body. However, it is not possible to sort out a battery in which no short circuit occurs between the outer can and the negative electrode but a short circuit occurs temporarily, for example, simply because the negative electrode external terminal and the outer can come into contact simultaneously with a manufacturing apparatus or the like during the manufacturing process.

Therefore, with the test methods for sealed batteries as disclosed in the related arts, it is difficult to sort out a lithium-ion secondary battery having a metal outer can in which no short circuit occurs between the outer can and the negative electrode but a short circuit occurs temporarily, for example, simply because the negative external terminal and the outer can come into contact simultaneously with a manufacturing apparatus or the like during the manufacturing process.

### SUMMARY

An advantage of some aspects of the present invention provides a test method for a lithium-ion secondary battery that allows easy detection of a lithium-ion secondary battery in which a short circuit occurs temporarily, for example, when the negative electrode external terminal and the outer can come into contact simultaneously with a manufacturing apparatus or the like during manufacturing of the battery, whereby a reliable lithium-ion secondary battery can be sorted out with a reduced possibility of corrosion of the outer can due to lithium metal deposited on the inner surface of the outer can.

An aspect of the invention provides a test method for a lithium-ion secondary battery including: an electrode assembly in which a positive electrode plate including a positive electrode mixture containing a positive electrode active material capable of absorption and desorption of lithium ions and a negative electrode plate including a negative electrode mixture containing a negative electrode active material capable of absorption and desorption of lithium ions are stacked, or stacked and wound with a separator interposed therebetween, an aluminum or aluminum alloy outer can, and an aluminum or aluminum alloy sealing plate to which a positive electrode external terminal electrically connected to the positive electrode plate and a negative electrode external terminal electrically connected to the negative electrode plate are attached in an insulated state. The sealing plate is fixed to a mouth portion of the outer can in a sealed state so as to be electrically connected to the outer can. The electrode assembly is enclosed together with nonaqueous electrolyte in the outer can. This test method includes, after the lithium-ion secondary battery is subjected to a charging process, measuring a potential difference Δ between the outer can or the sealing plate and the negative electrode external terminal, and if the potential difference Δ is a predetermined prescribed value or greater, determining the battery as a non-defective product.

In the test method for a lithium-ion secondary battery according to this aspect of the invention, the potential difference Δ between the outer can or the sealing plate and the negative electrode external terminal is measured after the charging process, and if the potential difference is a predetermined prescribed value or greater, the battery is determined as a non-defective product. An outer can essentially has no polarity. However, in a lithium-ion secondary battery, if a short circuit occurs even temporarily because of contact between the negative electrode and the outer can or the sealing plate during the manufacturing process, or if the outer can and the negative electrode collector come into contact with each other temporarily inside the battery, for example, electrons may flow from the negative electrode to the outer can, and in addition, lithium ions may dissolve from the negative electrode into the nonaqueous electrolyte. Those lithium ions may be attracted to the electrons charged on the outer can and be deposited on the inner surface of the outer can as lithium metal.

At that time, a potential difference occurs between the outer can/sealing plate and the positive electrode plate or the negative electrode plate. However, in a lithium-ion secondary battery, since the range of changes of negative electrode potential with respect to the changing SOC of the battery is smaller than the range of changes of positive electrode potential, the potential difference between the negative electrode external terminal and the outer can or the sealing plate can be used as a basis for determination to sort out a battery in which a short circuit is caused, even temporarily, for example, by contact between the negative electrode and the outer can or the sealing plate during the manufacturing process. Therefore, with the test method for a lithium-ion secondary battery according to the aspect of the invention, it is possible to easily detect a lithium-ion secondary battery in which a short circuit occurs temporarily, for example, when the negative electrode external terminal and the outer can or the sealing plate come into contact simultaneously with a manufacturing apparatus or the like during manufacturing of the battery, whereby it becomes possible to sort out a reliable lithium-ion secondary battery with a reduced possibility of corrosion of the outer can due to lithium metal deposited on the inner surface of the outer can.

Examples of the positive electrode active material used in the lithium-ion secondary battery to which the test method according to the aspect of the invention is applicable include lithium composite oxides such as lithium cobalt oxide (LiCoO₂), lithium manganese oxide (LiMn₂O₄), lithium nickel oxide (LiNiO₂), lithium-nickel-manganese composite oxide (LiNi₁₋ₓMnₓO₂ (0<x<1)), lithium-nickel-cobalt composite oxide (LiNi₁₋ₓCoₓO₂ (0<x<1)), or lithium-nickel-cobalt-manganese composite oxide (LiNiₓCo_{y}Mn_{z}O₂ (0<x, y, z<1, x+y+z=1)). Al, Ti, Zr, Nb, B, Mg, Mo, or the like may be added to the lithium composite oxides. For example, a lithium-transition metal composite oxide represented by Li₁₊ₐNiₓCo_{y}Mn_{z}M_{b}O₂ may be used (where M is an element of at least one kind selected from Al, Ti, Zr, Nb, B, Mg, and Mo, 0≦a≦0.2, 0.2≦x≦0.5, 0.2≦y≦0.5, 0.2≦z≦0.4, 0≦b≦0.02, a+b+x+y+z=1).

As the negative electrode active material, a carbon material capable of absorption and desorption of lithium ions may be used. Examples of the carbon material capable of absorption and desorption of lithium ions include graphite, non-graphitizable carbon, graphitizable carbon, fibrous carbon, coke, and carbon black. Among these, graphite is particularly preferable.

As a nonaqueous solvent (organic solvent) in the nonaqueous electrolyte of the lithium-ion secondary battery to which the test method according to the aspect of the invention is applicable, for example, carbonates, lactones, ethers, or esters may be used, which have been generally used in nonaqueous electrolyte secondary batteries. For example, as carbonates, cyclic carbonate such as ethylene carbonate (EC), propylene carbonate (PC), or butylene carbonate (BC), or chain carbonate such as dimethyl carbonate (DMC), ethyl methyl carbonate (EMC), or diethyl carbonate (DEC) may be used.

In particular, it is preferable to use cyclic carbonate and chain carbonate in a range of 10:90 to 40:60 by volume ratio in view of the viscosity and ion conductivity of the solvent. Part or all of the hydrogen groups of these carbonates may be fluorinated. An unsaturated cyclic carbonate ester such as vinylene carbonate (VC) may be added to the nonaqueous electrolyte. Not only a liquid nonaqueous electrolyte but also a gelled nonaqueous electrolyte may be used in the lithium-ion secondary battery used in the invention.

As electrolytic salt that may be used in the nonaqueous electrolyte of the lithium-ion secondary battery to which the test method according to the aspect of the invention is applicable, electrolytic salt generally used in lithium-ion secondary batteries can be used. For example, LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, LiP(C₂O₄)F₄, and a mixture thereof may be used. Among these, LiPF₆ is particularly preferable. The dissolved amount of the solute to the nonaqueous solvent is preferably 0.5 to 2.0 mol/L.

In the test method for a lithium-ion secondary battery according to the aspect of the invention, it is preferable that the potential difference Δ be measured in a state in which SOC is 10% to 100%.

In a lithium-ion secondary battery, as SOC changes, the battery voltage also changes. If SOC is in a range of 10% to 100%, the extent of changes of battery voltage is smaller than when SOC is less than 10%, and, in addition, the potential of the negative electrode hardly changes. Therefore, it becomes possible to accurately detect a battery in which a short circuit occurs temporarily, for example, when the negative electrode external terminal and the outer can or the sealing plate come into contact simultaneously with a manufacturing apparatus or the like.

In the test method for a lithium-ion secondary battery according to the aspect of the invention, it is preferable that the potential difference Δ be measured in a state in which SOC is 10% to 100%, and that the prescribed value as a basis for determination of a non-defect product be set to a value equal to or greater than 1.50 V.

In the test method for a lithium-ion secondary battery according to the aspect of the invention, the potential difference Δ is measured in a state in which SOC is 10% to 100%, and a prescribed value as a basis for determination of a non-defect product is set to a value equal to or greater than 1.50 V in accordance with SOC in the measurement, whereby it becomes possible to more accurately detect a battery in which a short circuit occurs temporarily, for example, when the negative electrode external terminal and the outer can or the sealing plate come into contact simultaneously with a manufacturing apparatus or the like.

### BRIEF DESCRIPTION OF THE DRAWINGS

The invention will be described with reference to the accompanying drawings, wherein like numbers reference like elements.

FIG. 1 is a perspective view of a prismatic lithium-ion secondary battery produced in each example.

FIG. 2A is a front view showing an internal structure of the prismatic lithium-ion secondary battery in FIG. 1, and FIG. 2B is a cross-sectional view along line IIB-IIB in FIG. 2A.

FIG. 3 is a graph showing the relation between SOC, potential of each electrode, and battery voltage.

### DESCRIPTION OF EXEMPLARY EMBODIMENTS

In the following, examples of the invention will be described using the drawings. It is noted that each example below is only shown by way of example in which a test method for a lithium-ion secondary battery for embodying the technical concept of the invention is applied to a prismatic lithium-ion secondary battery, and it is not intended that the invention is only applied to a prismatic lithium-ion secondary battery. The invention is equally adaptive to any other embodiments embraced in the appended claims.

Production of Positive Electrode Plate

Li₂CO₃ and (Ni_{0.35}Cu_{0.35}Mn_{0.3})₃O₄ were mixed together such that the mole ratio between Li and (Ni_{0.35}Cu_{0.35}Mn_{0.3}) was 1:1. Then, the mixture was burned at 900° C. in the air atmosphere for 20 hours, resulting in lithium-transition metal oxide represented by LiNi_{0.35}Cu_{0.35}Mn_{0.3}O₂ serving as a positive electrode active material. The resultant positive electrode active material, flaked graphite and carbon black as conductive materials, and N-methylpyrrolidone (NMP) solution of polyvinylidene fluoride (PVdF) as a binding agent were kneaded such that the mass ratio of lithium-transition metal oxide:flaked graphite:carbon black:PVdF was 88:7:2:3. Positive electrode active material slurry was thus prepared.

Then, the slurry was applied to both surfaces of a 15-μm-thick aluminum alloy foil so as to form a positive electrode substrate-exposed portion such that the aluminum alloy foil remained exposed in the shape of a stripe along one end side in the width direction. The slurry was thereafter dried to remove NMP used as a solvent during production of the positive electrode active material slurry. A positive electrode active material mixture layer was thus formed. Thereafter, the mixture layer was rolled using a roller to have a prescribed packing density (2.61 g/cc) and then cut into a prescribed size, resulting in a positive electrode plate.

Production of Negative Electrode Plate

Artificial graphite as a negative electrode active material, carboxymethyl cellulose (CMC) as a thickening agent, and styrene-butadiene-rubber (SBR) as a binding agent were kneaded with water to prepare negative electrode active material slurry. Here, the mass ratio of the negative electrode active material:CMC:SBR was 98:1:1. Then, the slurry was applied to both surfaces of a 10-μm-thick copper foil so as to form a negative electrode substrate-exposed portion such that the copper foil remained exposed in the shape of a stripe along one end side in the width direction. Thereafter, the slurry was dried to remove water used as a solvent during production of the slurry. A negative electrode active material mixture layer was thus formed. Thereafter, the mixture layer was rolled using a roller to have a prescribed packing density (1.11 g/cc) and then cut into a prescribed size, resulting in a negative electrode plate before formation of a protection layer.

Then, alumina, a binding agent, and NMP as a solvent were mixed together at a mass ratio of 30:0.9:69.1 and subjected to a bead mill mixing and dispersing process to prepare protection layer slurry. The protection layer slurry thus prepared was applied on the negative electrode active material mixture layer. NMP used as a solvent was thereafter dried and removed, so that a protection layer made of alumina and the binding agent was formed on the surface of the negative electrode active material mixture layer. The resultant product was cut into a prescribed size to form a negative electrode plate. It is noted that the thickness of the protection layer made of alumina and the binding agent was 3 μm.

Preparation of Electrolytic Solution

In each example, a mixed solvent at a ratio of EC:EMC=3:7 (volume ratio) was used as a nonaqueous solvent of a nonaqueous electrolytic solution, with the addition of LiPF₆ at 1 mol/L as electrolytic salt and with the addition of VC at 1 mass % with respect to the entire electrolytic solution.

Production of Flat Wound Electrode Assembly

A flat wound electrode assembly 11 was produced using the positive electrode plate and the negative electrode plate produced as described above. The positive electrode plate and the negative electrode plate were wound in a flat shape with a porous separator of polyethylene (not shown) interposed therebetween such that the positive electrode substrate-exposed portion is located on one end and the negative electrode substrate-exposed portion is located on the other end in the winding axis direction.

Production of Prismatic Lithium-Ion Secondary Battery

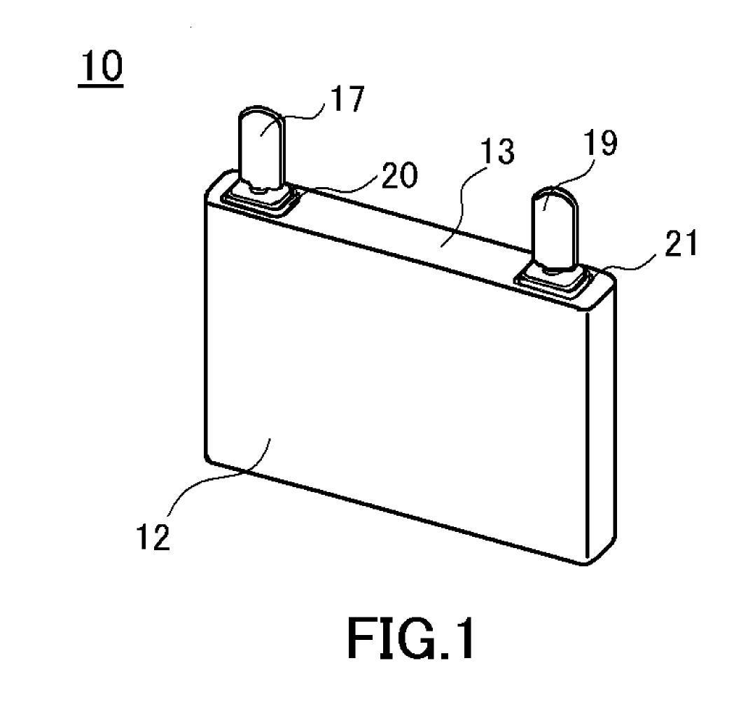

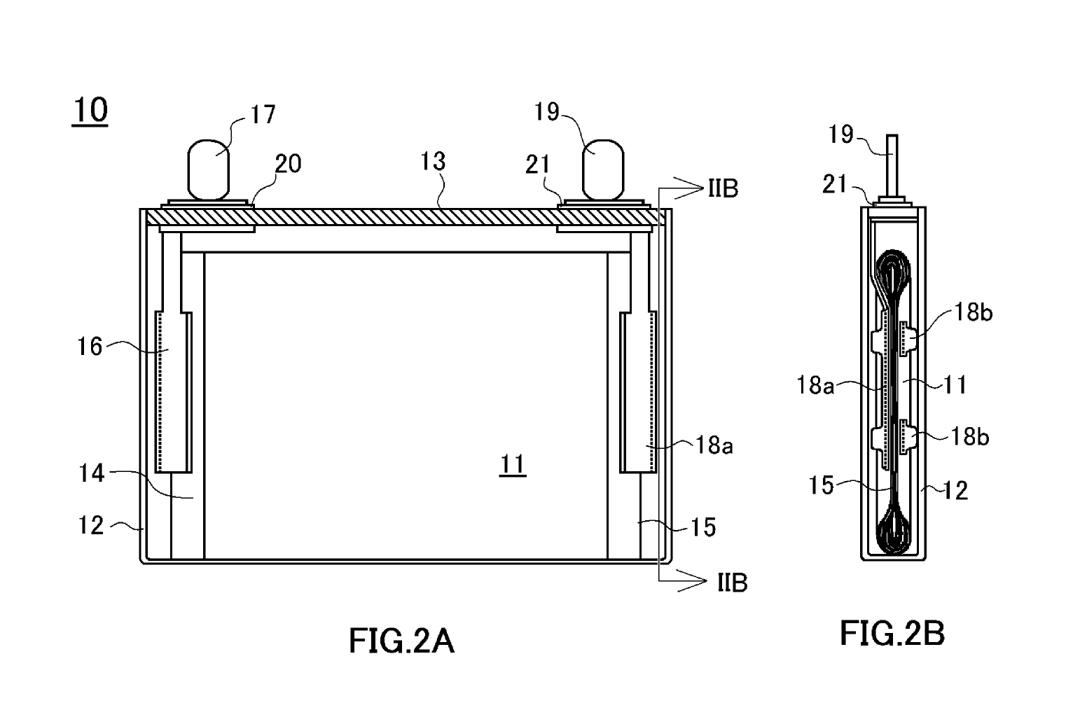

A structure of a prismatic lithium-ion secondary battery used for measurement in each example will be described using FIG. 1 and FIG. 2. FIG. 1 is a perspective view of a prismatic lithium-ion secondary battery common to the examples. FIG. 2A is a front view showing an internal structure of the prismatic lithium-ion secondary battery in FIG. 1, and FIG. 2B is a cross-sectional view along line IIB-IIB in FIG. 2A.

In a prismatic lithium-ion secondary battery 10, the flat wound electrode assembly 11 formed by winding the positive electrode plate and the negative electrode plate with a separator (neither of which are shown) interposed therebetween is accommodated in a prismatic outer can 12, and the outer can 12 is sealed with a sealing plate 13. Although both the outer can 12 and the sealing plate 13 are formed of aluminum or aluminum alloy, they may be formed of different materials.

A positive electrode substrate-exposed portion 14 is connected to a positive electrode external terminal 17 via a positive electrode collector 16, and a negative electrode substrate-exposed portion 15 is connected to a negative electrode external terminal 19 via a negative electrode collector 18a. The positive electrode external terminal 17 and the negative electrode external terminal 19 are fixed to the sealing plate 13 via insulating members 20 and 21, respectively. The lithium-ion secondary battery 10 was produced by inserting the flat wound electrode assembly 11 into the prismatic outer can 12, thereafter laser-welding the sealing plate 13 to the mouth portion of the outer can 12, then pouring the above-noted nonaqueous electrolytic solution from an electrolyte pour hole (not shown), and sealing the electrolyte pour hole.

The assembly of the lithium-ion secondary battery is carried out as follows. First, the positive electrode external terminal 17 and the positive electrode collector 16 are crimped and fixed to the sealing plate 13, and the negative electrode external terminal 19 and the negative electrode collector 18a are crimped and fixed, similarly. Then, the positive electrode collector 16 and a positive electrode collector receiving part (not shown) are brought into abutment with the positive electrode substrate-exposed portion 14 of the flat wound electrode assembly 11 and fixed thereto by resistance welding. The negative electrode collector 18a and a negative electrode collector receiving part 18b are brought into abutment with the negative electrode substrate-exposed portion 15 and fixed thereto by resistance welding. Thereafter, the outer periphery of the flat wound electrode assembly 11 is covered with an insulating sheet (not shown). The flat wound electrode assembly 11 is then inserted together with the insulating member into the prismatic outer can 12, and the sealing plate 13 is fitted in the mouth portion of the outer can 12. The fitting portion between the sealing plate 13 and the outer can 12 is laser-welded.

Here, one polypropylene insulating sheet was used as the insulating sheet and folded in the shape of a bag. The flat wound electrode assembly 11 was inserted in the bag, whereby the periphery of the flat wound electrode assembly 11 is insulated. The material of the insulating sheet may be selected as appropriate from polypropylene, polyethylene, polyphenylene sulfide, polyether ether ketone, nylon, and the like. The insulating sheet may be either porous or non-porous as long as it can prevent the flat wound electrode assembly 11 from being in direct contact with the outer can 12. It is noted that, in the lithium-ion secondary battery to which the test method according to an embodiment of the invention is applicable, it is necessary to allow ion conduction between the flat wound electrode assembly 11 and the outer can 12 through the electrolytic solution. Therefore, when a non-porous insulating sheet is used, ions are allowed to move through a gap produced in the folded insulating sheet. With this structure, the outer can and the sealing plate do not have polarity with respect to the positive electrode plate and the negative electrode plate.

A prescribed amount of the electrolytic solution prepared as described above was poured from the not-shown electrolyte pour hole and held in a state of −0.05 MPa for 10 seconds for infiltration. Then, a preliminary charge process was performed at a current value of 1 A for 10 seconds and then at a current value of 20 A for 10 seconds, resulting in the prismatic lithium-ion secondary battery 10. Thereafter, the battery was charged to SOC 50% and left in the environment at 65° C. for one day of aging.

Test Procedure

Prior to measurement of a potential difference between the negative electrode and the outer can, in order to adjust SOC of each battery as a measurement target, each battery was completely discharged and then constant-current charged up to 10% of the predetermined capacity of each battery. The potential difference between the negative electrode external terminal and the outer can was measured using an ordinary tester (model 3266-50 manufactured by HIOKI E.E. CORPORATION) by connecting the tip ends of test leads connected to a V terminal and a COM terminal of the tester to the outer can and the negative electrode external terminal, respectively, of each battery.

Verification Experiment

In order to verify the test method according to the embodiment of the invention, an external short circuit caused, for example, by contact of the negative electrode external terminal with the outer can or the sealing plate during the manufacturing process, was replicated by subjecting the resultant prismatic lithium-ion secondary battery to the following process. First, the tip ends of positive electrode and negative electrode lead wires of a constant current power source were connected to the negative electrode external terminal of each test battery and the outer can of the battery, respectively, to feed constant current. This power feeding process was performed for six batteries for various time amounts: at 0.10 mA for 50 seconds for a battery 1, at 0.10 mA for 200 seconds for a battery 2, at 0.10 mA for 500 seconds for a battery 3, at 0.10 mA for 700 seconds for a battery 4, at 0.10 mA for 2000 seconds for a battery 5, and at 100 mA for 16 hours for a battery 6. As a result, the six batteries had respective different potentials between the outer can and the negative electrode external terminal.

Next, in order to examine the deposition state of lithium, which was assumed to be deposited on the inner surface of the outer can through the power feeding process, the deposition state was determined by visual inspection, and quantitative analysis of the lithium deposition amount was performed by inductively-coupled plasma (ICP) optical emission spectrometry. For ICP optical emission spectrometry, the battery subjected to the power feeding process was disassembled, and the flat wound electrode assembly, the insulating sheet, and the electrolytic solution were removed from the outer can. The outer can was then cleaned with dimethyl carbonate (DMC) and immersed in one-liter of pure water, so that lithium assumed to be deposited on the inner surface of the outer can was extracted as lithium ions in water. A measurement aqueous solution for ICP optical emission spectrometry was thus prepared. Then, the concentration of lithium ions included in the aqueous solution was measured with an ICP optical emission spectrometer (SPS-3100 manufactured by SII Nano Technology Inc.). The results are shown in Table 1. It is noted that the detection limit of lithium in this experiment is about 1 μg/L.

TABLE 1

| | Outer | | | | |
|---|---|---|---|---|---|
| | can-negative | Power feeding process | | Li | Li deposition |
| | electrode | Current | | deposition | state (visual |
| | potential (V) | (mA) | Process time | amount (μm) | inspection) |
| Battery 1 | 2.30 | 0.10 | 50 seconds | — | Not observed |
| Battery 2 | 1.83 | 0.10 | 200 seconds | — | Not observed |
| Battery 3 | 1.50 | 0.10 | 500 seconds | — | Not observed |
| Battery 4 | 1.45 | 0.10 | 700 seconds | 2.1 | Not observed |
| Battery 5 | 1.05 | 0.10 | 2000 seconds | 10.5 | Not observed |
| Battery 6 | −0.24 | 100 | 16 hours | 440,000 | Deposition observed |

As can be understood from the results shown in Table 1, if the potential difference Δ between the outer can and the sealing plate and the negative electrode external terminal is at least 1.50 V or higher at SOC 10%, the amount of deposited lithium is equal to or smaller than the detection limit. Therefore, even when an external short circuit occurs between the outer can or the sealing plate and the negative electrode external terminal for a short time, lithium is scarcely deposited on the inner surface of the outer can, and it is determined that the battery is free from the possibility of corrosion due to alloying of lithium with aluminum or aluminum alloy of the outer can. Accordingly, it was determined that the test method according to the embodiment of the invention is an effective way to determine a reliable battery.

Determination of Optimum SOC Range

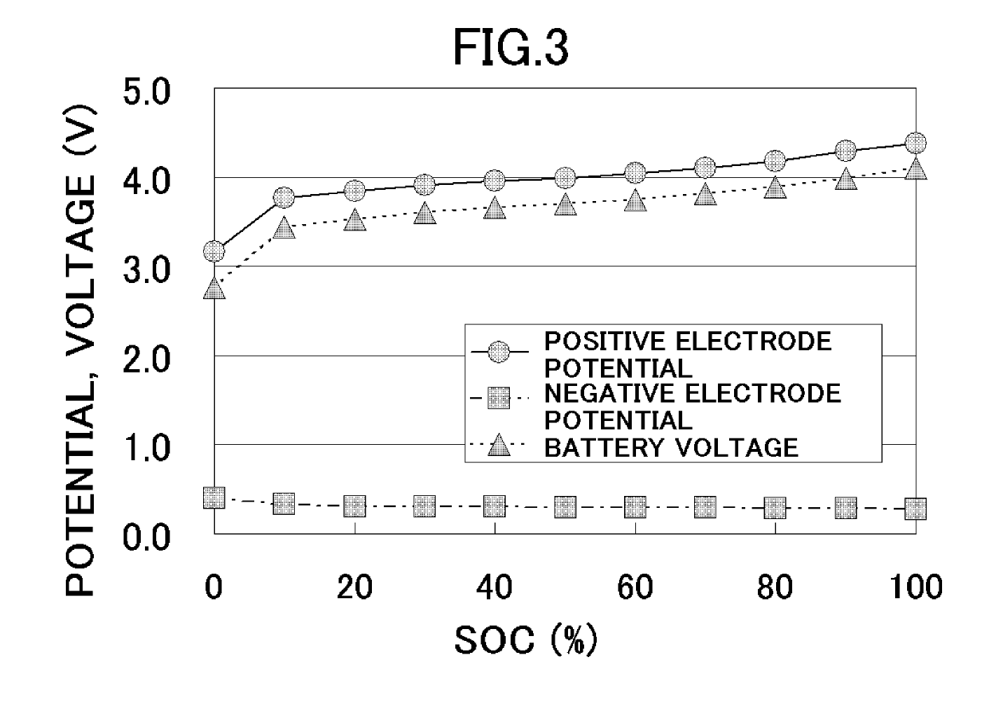

In the experiment above, the measurement was performed at SOC of 10%. Here, in order to determine an effective SOC range, the changes of positive electrode potential and negative electrode potential with respect to SOC of an actual battery were determined as follows. First, 11 batteries in the same lot were prepared, and SOC was adjusted every 10% in the range from 0 to 100%, using a charger/discharger. The safety valve of each battery was opened in a glove box, and a lithium foil serving as a counter electrode was soaked through the open safety valve into the electrolytic solution. Then, the positive electrode potential, the negative electrode potential, and the battery voltage were measured. The results are shown in Table 2 and FIG. 3.

TABLE 2

| SOC | Battery | Positive electrode | Negative electrode |
|---|---|---|---|
| (%) | voltage (V) | potential (V vs. Li/Li+) | potential (V vs. Li/Li+) |
| 0 | 2.76 | 3.16 | 0.40 |
| 10 | 3.44 | 3.77 | 0.33 |
| 20 | 3.53 | 3.84 | 0.31 |
| 30 | 3.60 | 3.91 | 0.31 |
| 40 | 3.66 | 3.96 | 0.30 |
| 50 | 3.70 | 3.99 | 0.30 |
| 60 | 3.75 | 4.04 | 0.30 |
| 70 | 3.81 | 4.10 | 0.29 |
| 80 | 3.89 | 4.18 | 0.29 |
| 90 | 3.99 | 4.29 | 0.29 |
| 100 | 4.10 | 4.38 | 0.28 |

The behaviors of the positive electrode potential and the negative electrode potential suggest the following. First, it can be clearly understood that the range of changes of positive electrode potential with respect to the changing SOC of the battery is greater than the range of changes of negative electrode potential. Therefore, it is clear that whether there exists an external short circuit caused, for example, by contact of the negative electrode external terminal with the outer can or the sealing plate during the manufacturing process can be determined more correctly based on the potential difference between the negative electrode external terminal and the outer can or the sealing plate, than based on the potential difference between the positive electrode external terminal and the outer can or the sealing plate.

In the range of SOC 10% to 100%, the extent of changes of the negative electrode potential with respect to the changes of SOC is small as compared with SOC of less than 10%, and the negative electrode potential hardly changes. Therefore, SOC 10% to 100% is considered to be more effective in measuring the potential difference between the negative electrode external terminal and the outer can or the sealing plate.

In the test process, it is not necessary to use a battery in a fully charged state or a state close to fully charged for measurement. A prescribed SOC set within 10 to 40% is preferable because the time required for charging can be reduced. In the present invention, SOC 10%, adopted in the actual test process, can be employed. Here, if SOC of a battery to be tested is different from 10%, the potential difference Δ between the negative electrode and the outer can or the sealing plate is adjusted to serve as a reference for the measurement results, so that the present test method can be applied. For example, if SOC of a battery serving as a measurement target is 20%, a battery having a potential difference Δ equal to or greater than 1.52 V, higher by 0.02 V, is determined as a non-defective product.

Although a prismatic lithium-ion secondary battery using a flat wound electrode assembly has been illustrated in the foregoing examples, the present invention is not limited thereto and is also applicable to a prismatic lithium-ion secondary battery using a stack-type electrode assembly or a cylindrical or elliptic cylindrical lithium-ion secondary battery using a wound electrode assembly. In this case, the potential difference Δ between the negative electrode external terminal and the outer can or the sealing plate of a battery that ensures reliability may be determined by conducting the negative electrode external terminal—outer can short circuit experiment and by measuring the negative electrode potential with respect to SOC, similarly to the foregoing examples. In the present invention, the shape of the positive electrode external terminal and the negative electrode external terminal is not limited to the shape shown in FIG. 1. For example, a hole or a bolt portion for connection may be formed therein.

What is claimed is:

1. A test method for a lithium-ion secondary battery including: an electrode assembly in which a positive electrode plate including a positive electrode mixture containing a positive electrode active material capable of absorption and desorption of lithium ions and a negative electrode plate including a negative electrode mixture containing a negative electrode active material capable of absorption and desorption of lithium ions are stacked, or stacked and wound with a separator interposed therebetween, an aluminum or aluminum alloy outer can, and an aluminum or aluminum alloy sealing plate to which a positive electrode external terminal electrically connected to the positive electrode plate and a negative electrode external terminal electrically connected to the negative electrode plate are attached in an insulated state, the sealing plate being fixed to a mouth portion of the outer can in a sealed state so as to be electrically connected to the outer can, and the electrode assembly being enclosed together with nonaqueous electrolyte in the outer can, the test method comprising:
after the lithium-ion secondary battery is subjected to a charging process, measuring a potential difference Δ between the outer can or the sealing plate and the negative electrode external terminal; and
if the potential difference Δ is a predetermined prescribed value or greater, determining the battery as a non-defective product.

2. The test method for a lithium-ion secondary battery according to claim 1, wherein the potential difference Δ is measured in a state in which state of charge is 10% to 100%.

3. The test method for a lithium-ion secondary battery according to claim 2, wherein the prescribed value of the potential difference Δ is set to a value equal to or greater than 1.50 V.
